(19) United States
(12) Patent Application Publication
(10) Pub. No.: US 2014/0081802 A1
(43) Pub. Date: Mar. 20, 2014

(54) TICKET PURCHASING SYSTEM, CONTROL METHOD FOR TICKET PURCHASING SYSTEM, PROGRAM AND RECORDING MEDIUM

(71) Applicant: Suguru Oiwa, Shinagawa-ku (JP)

(72) Inventor: Suguru Oiwa, Shinagawa-ku (JP)

(73) Assignee: Rakuten, Inc., Shinagawa-ku, Tokyo (JP)

(21) Appl. No.: 14/115,488

(22) PCT Filed: May 25, 2012
(86) PCT No.: PCT/JP2012/063545

§ 371 Date: Nov. 4, 2013

(30) Foreign Application Priority Data
Jun. 30, 2011 (JP) 2011-146591

(51) Int. Cl. G06Q 30/06

(52) U.S. Cl. CPC G06Q 30/0633
USPC 705/26.8

(57) ABSTRACT

Provided is a betting ticket purchase system capable of reducing the number of betting requests for betting tickets that have been received but are not processed by a betting deadline. A betting request receiving unit (22) receives a purchase request for any one of a plurality of betting tickets having the purchase deadlines which arrive sequentially. A processing unit (24) processes the betting requests in the order of reception. Under the condition that conditions that the number of unprocessed purchase requests is a given number or larger and that a plurality of purchase requests of the unprocessed purchase requests whose places in a reception order are smaller than the given number include a purchase request for a betting ticket having the purchase deadline which does not arrive at the earliest time are satisfied, the processing unit (24) processes a purchase request for a betting ticket having the purchase deadline which arrives at the earliest time before the purchase request for the betting ticket having the purchase deadline which does not arrive at the earliest time.

### TECHNICAL FIELD

The present invention relates to a betting ticket purchase system, a control method for a betting ticket purchase system, a program, and a recording medium.

### BACKGROUND ART

There are betting ticket purchase systems that process requests to purchase betting tickets such as horse race betting tickets or football betting tickets. In the betting ticket purchase system, it is common to receive purchase requests not only for betting tickets having a purchase deadline which arrives at the earliest time but also for betting tickets having the purchase deadlines which arrive after that purchase deadline. An example of the technology for processing the purchase requests for the betting tickets is disclosed in Patent Literature 1, in which a request from a terminal, such as a purchase request, is registered by adding to the tail end of a queue, and requests are taken out of the queue in order from the head of the queue to be processed.

### CITATION LIST

### Patent Literature

[Patent Literature 1] WO 2003/067483 A1

### SUMMARY OF INVENTION

### Technical Problem

The purchase requests for betting tickets are known to be made in a concentrated manner immediately before a betting deadline of the betting tickets. However, even immediately before the purchase deadline of betting tickets, a general betting ticket purchase system receives purchase requests for betting tickets having the purchase deadlines which arrive after that of those betting tickets. If the purchase requests for betting tickets are processed in the order of reception, the purchase requests for betting tickets which do not need to be processed immediately are therefore processed before the purchase request for betting tickets having the purchase deadline that arrives at the earliest time, and there is a fear that the purchase request for betting tickets which have been received but are not processed by the purchase deadline may arise.

The present invention has been made in view of the above-mentioned problem, and has an object to reduce the number of betting requests for betting tickets that have been received but are not processed by a purchase deadline.

### Solution to Problem

In order to solve the above-mentioned problem, according to the present invention, there is provided a betting ticket purchase system, which is configured to receive, before a purchase deadline which arrives at an earliest time, a purchase request for a betting ticket having the purchase deadline which arrives after the purchase deadline, the betting ticket purchase system including: receiving means for receiving a purchase request for any one of a plurality of betting tickets having the purchase deadlines which arrive sequentially; determining means for determining whether or not conditions that a number of unprocessed purchase requests is a given number or larger and that a plurality of purchase requests of the unprocessed purchase requests whose places in a reception order are smaller than the given number include a purchase request for a betting ticket having the purchase deadline which does not arrive at the earliest time are satisfied; and processing means for processing, under a condition that it is determined that the conditions are satisfied, a purchase request for a betting ticket having the purchase deadline which arrives at the earliest time before the purchase request for the betting ticket having the purchase deadline which does not arrive at the earliest time.

Further, according to the present invention, there is provided a control method for a betting ticket purchase system, which is configured to receive, before a purchase deadline which arrives at an earliest time, a purchase request for a betting ticket having the purchase deadline which arrives after the purchase deadline, the control method including the steps of: receiving a purchase request for any one of a plurality of betting tickets having the purchase deadlines which arrive sequentially; determining whether or not conditions that a number of unprocessed purchase requests is a given number or larger and that a plurality of purchase requests of the unprocessed purchase requests whose places in a reception order are smaller than the given number include a purchase request for a betting ticket having the purchase deadline which does not arrive at the earliest time are satisfied; and processing, under a condition that it is determined that the conditions are satisfied, a purchase request for a betting ticket having the purchase deadline which arrives at the earliest time before the purchase request for the betting ticket having the purchase deadline which does not arrive at the earliest time.

Further, according to the present invention, there is provided a program for causing a computer to function as a betting ticket purchase system, which is configured to receive, before a purchase deadline which arrives at an earliest time, a purchase request for a betting ticket having the purchase deadline which arrives after the purchase deadline, the program further causing the computer to function as: receiving means for receiving a purchase request for any one of a plurality of betting tickets having the purchase deadlines which arrive sequentially; determining means for determining whether or not conditions that a number of unprocessed purchase requests is a given number or larger and that a plurality of purchase requests of the unprocessed purchase requests whose places in a reception order are smaller than the given number include a purchase request for a betting ticket having the purchase deadline which does not arrive at the earliest time are satisfied; and processing means for processing, under a condition that it is determined that the conditions are satisfied, a purchase request for a betting ticket having the purchase deadline which arrives at the earliest time before the purchase request for the betting ticket having the purchase deadline which does not arrive at the earliest time.

Further, according to the present invention, there is provided a recording medium having recorded thereon a program for causing a computer to function as a betting ticket purchase system, which is configured to receive, before a purchase deadline which arrives at an earliest time, a purchase request for a betting ticket having the purchase deadline which arrives after the purchase deadline, the program further causing the computer to function as: receiving means for receiving a purchase request for any one of a plurality of betting tickets having the purchase deadlines which arrive sequentially; determining means for determining whether or not conditions that a number of unprocessed purchase requests is a given number or larger and that a plurality of purchase requests of the unprocessed purchase requests whose places in a reception order are smaller than the given number include a purchase request for abetting ticket having the purchase deadline which does not arrive at the earliest time are satisfied; and processing means for processing, under a condition that it is determined that the conditions are satisfied, a purchase request for a betting ticket having the purchase deadline which arrives at the earliest time before the purchase request for the betting ticket having the purchase deadline which does not arrive at the earliest time.

According to the present invention, under the condition that the conditions that the number of unprocessed purchase requests is the given number or larger and that the plurality of purchase requests of the unprocessed purchase requests whose places in the reception order are smaller than the given number include the purchase request for the betting ticket having the purchase deadline which does not arrive at the earliest time are satisfied, the purchase request for the betting ticket having the purchase deadline which arrives at the earliest time is processed before the purchase request for the betting ticket having the purchase deadline which does not arrive at the earliest time, and the number of betting requests for betting tickets that have been received but are not processed by the betting deadline is therefore reduced.

In an aspect of the present invention, under a condition that it is determined that the conditions are satisfied, the betting ticket purchase system changes places of the purchase requests in a processing order so that the purchase request for the betting ticket having the purchase deadline which arrives at the earliest time is processed before the purchase request for the betting ticket having the purchase deadline which does not arrive at the earliest time.

Further, in an aspect of the present invention, the processing means changes places of the purchase requests in a processing order under a condition that a number of purchase requests received in a unit of time exceeds the given number.

Further, in an aspect of the present invention, the processing means processes the purchase request for the betting ticket having the purchase deadline which does not arrive at the earliest time after the purchase deadline which arrives at the earliest time.

Further, in an aspect of the present invention, the processing means processes the purchase request for the betting ticket having the purchase deadline which does not arrive at the earliest time under a condition that a period of time corresponding to a period of time from reception of the purchase request to arrival of the purchase deadline which arrives at the earliest time elapses from the purchase deadline.

Further, in an aspect of the present invention, the processing means processes the purchase request for the betting ticket having the purchase deadline which does not arrive at the earliest time after a purchase deadline of a betting ticket whose place in an arrival order is immediately before a place of the betting ticket in the arrival order.

Further, in an aspect of the present invention, the processing means processes the purchase request for the betting ticket having the purchase deadline which does not arrive at the earliest time under a condition that a period of time corresponding to a period of time from reception of the purchase request to the purchase deadline which arrives at the earliest time elapses from the purchase deadline of the betting ticket whose place in the arrival order is immediately before the place of the betting ticket in the arrival order.

Further, in an aspect of the present invention, the processing means determines whether or not to preferentially process a purchase request having the purchase deadline which arrives soon based on an execution margin of processing to be executed after the purchase deadline which arrives at the earliest time.

Further, in an aspect of the present invention, the execution margin is determined based on an receiving tendency in the purchase request for the betting ticket.

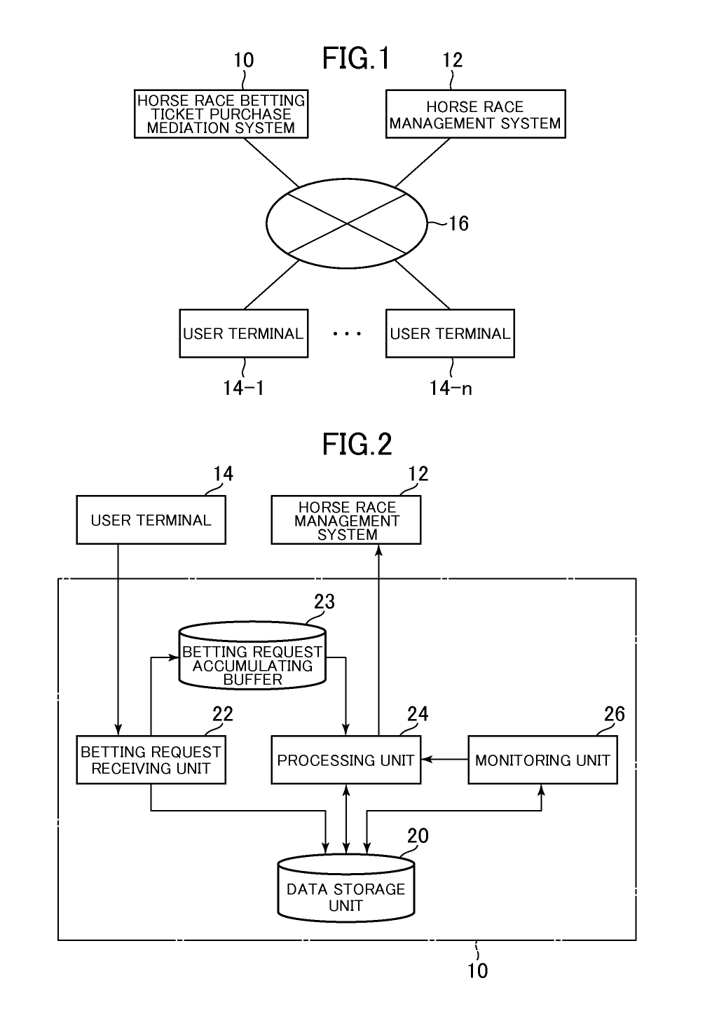

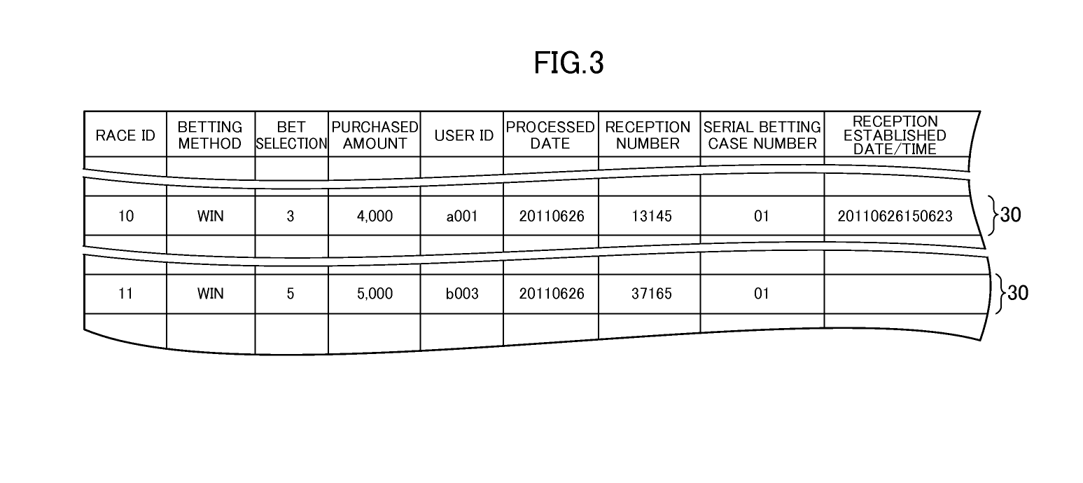

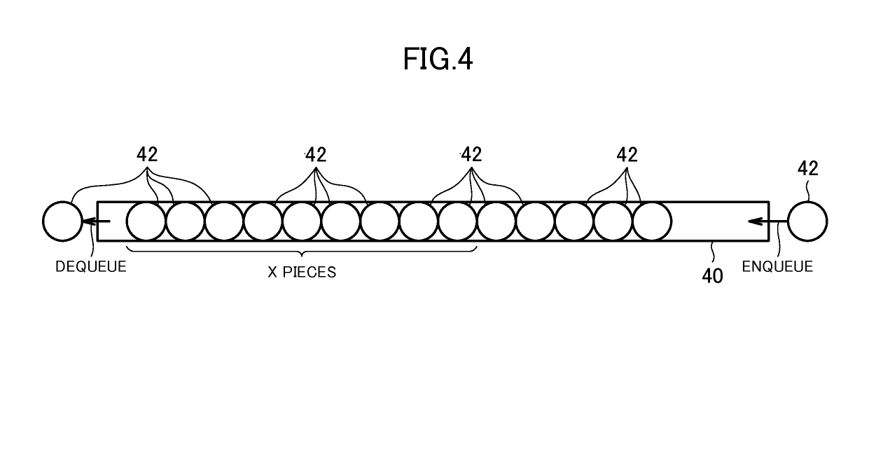

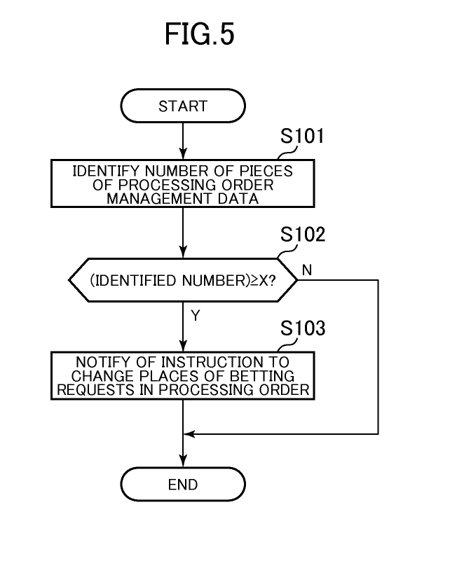

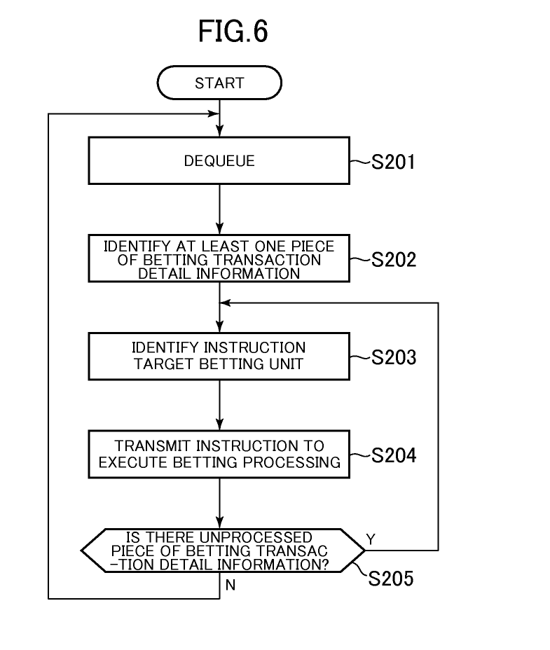

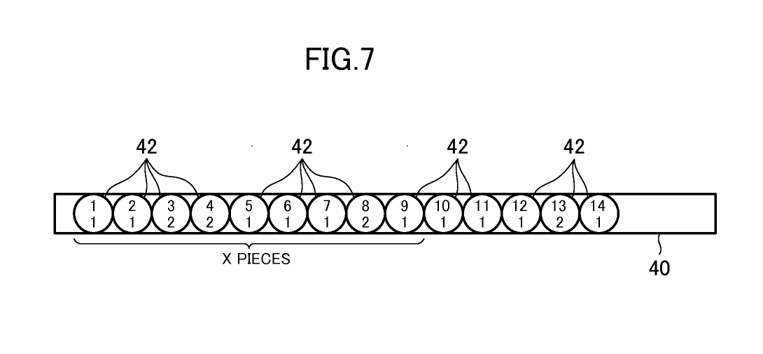

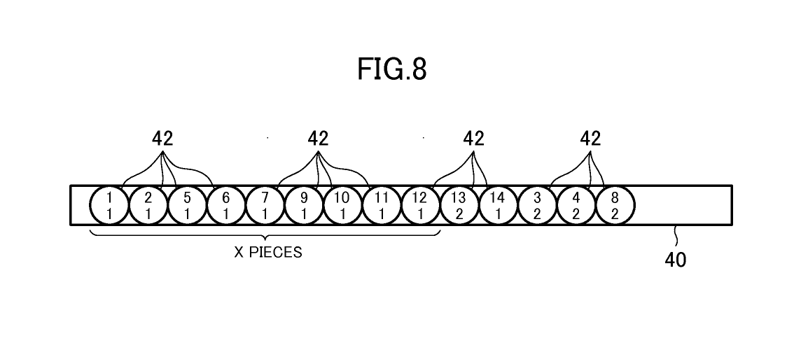

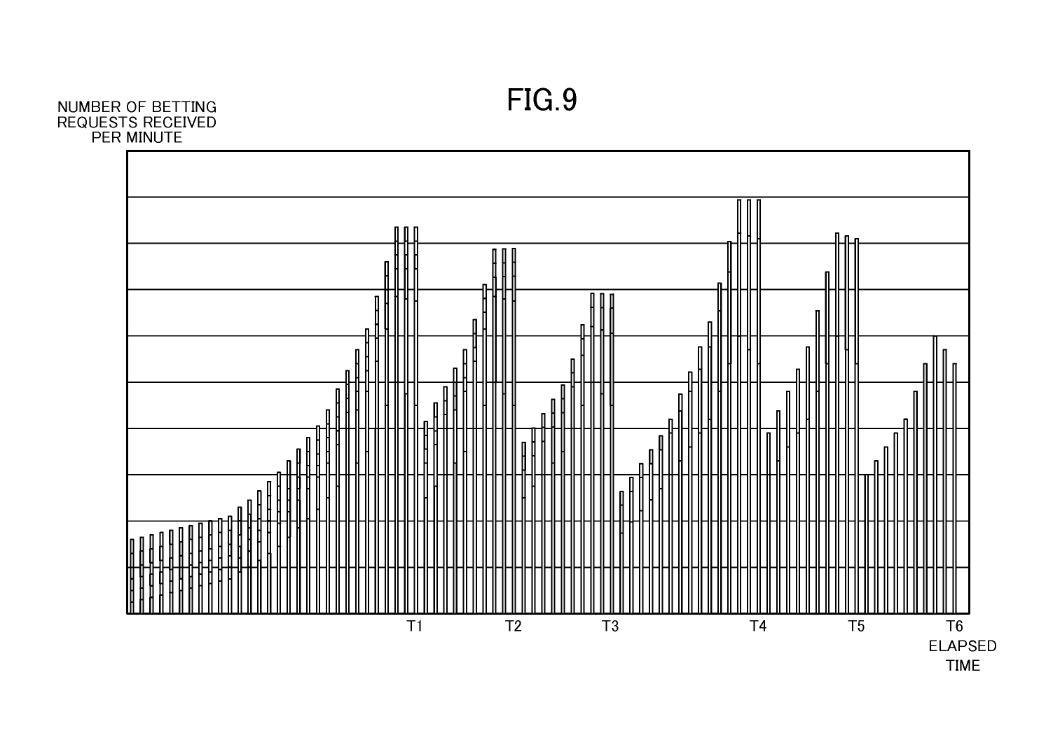

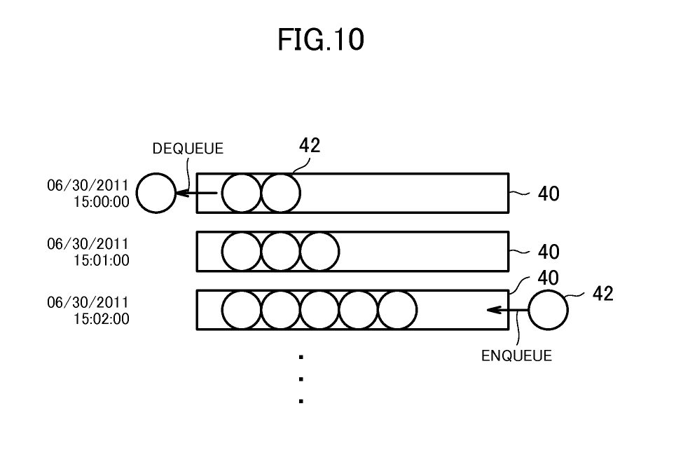

### BRIEF DESCRIPTION OF DRAWINGS

[FIG. 1] An overall configuration diagram of a computer network according to an embodiment of the present invention.

[FIG. 2] A functional block diagram illustrating an example of functions implemented in a horse race betting ticket purchase mediation system according to the embodiment of the present invention.

[FIG. 3] A diagram illustrating an example of betting transaction detail information.

[FIG. 4] A diagram schematically illustrating an example of a betting request management queue.

[FIG. 5] A flow chart illustrating an example of the flow of processing that is executed in the horse race betting ticket purchase mediation system according to the embodiment of the present invention.

[FIG. 6] A flow chart illustrating an example of the flow of processing that is executed in the horse race betting ticket purchase mediation system according to the embodiment of the present invention.

[FIG. 7] A diagram schematically illustrating an example of the betting request management queue.

[FIG. 8] A diagram schematically illustrating an example of the betting request management queue.

[FIG. 9] A graph schematically showing an example of an receiving tendency in betting requests received by the horse race betting ticket purchase mediation system according to the embodiment of the present invention.

[FIG. 10] A diagram schematically illustrating an example of the betting request management queues.

### DESCRIPTION OF EMBODIMENTS

An embodiment of the present invention is described in detail below with reference to the drawings.

FIG. 1 is an overall configuration diagram of a computer network according to the embodiment of the present invention. As illustrated in FIG. 1, a horse race betting ticket purchase mediation system 10, a horse race management system 12, and user terminals 14 (14-1 to 14-n), which are each configured with a computer as the main component, are connected to the computer network which is the Internet or the like and denoted by 16. The horse race betting ticket purchase mediation system 10, the horse race management system 12, and the user terminals 14 can communicate to/from one another.

The horse race betting ticket purchase mediation system 10 is a computer such as a Web server that functions as a betting ticket purchase system according to this embodiment. The horse race betting ticket purchase mediation system 10 according to this embodiment uses Web technologies to provide a large number of users with Web services such as a service of assisting users in purchasing a horse race betting ticket (in betting) at a horse race that is being held and a data providing service for providing data about a horse race.

The horse race management system 12 is a computer such as a server that is managed by the promoter of a horse race, and implements a function of executing horse race betting ticket purchase processing (betting processing) in response to the reception of a horse race betting ticket purchase request (betting request), a function of determining the odds based on the specifics of a betting request, a function of managing betting situations, a function of executing winning payment processing, and the like.

The horse race betting ticket purchase mediation system 10 according to this embodiment transmits an instruction to execute betting processing to the horse race management system 12 according to this embodiment in response to the reception of a betting request. The horse race management system 12 executes betting processing in response to the received execution instruction. Bets for which the execution of betting processing can be instructed in one transmission are hereinafter referred to as “betting unit”. The horse race betting ticket purchase mediation system 10 in this embodiment is designed so as to be capable of receiving betting requests that translate into a plurality of betting units by requesting betting once. The horse race management system 12 according to this embodiment executes betting processing also under the condition that execution instructions are received from other systems than the horse race betting ticket purchase mediation system 10 according to this embodiment.

The horse race betting ticket purchase mediation system 10 and the horse race management system 12 each include, for example, a control unit which is a program-controlled device such as a CPU that operates as programmed by a program installed in its own machine, a memory unit such as a ROM, a RAM, or other types of memory device, or a hard disk drive, and a communication unit which is a communication interface such as a network board. Those components are connected to one another via a bus. The memory unit of each of the horse race betting ticket purchase mediation system 10 and the horse race management system 12 stores a program that is executed by the control unit of its own machine. The memory unit of each of the horse race betting ticket purchase mediation system 10 and the horse race management system 12 also operates as a work memory of its own machine.

A large number of user terminals 14 which are managed by users of the horse race betting ticket purchase mediation system 10 are also connected to the computer network 16. The user terminals 14 are information processing devices such as personal computers, cellular phones, portable information terminals (personal digital assistants: PDAs), and smartphones. The user terminals 14 each include, for example, a control device such as a CPU, a storage device such as a ROM, a RAM, or other types of memory device, or a hard disk drive, an output device such as a display, an input device such as a mouse, a keyboard, a touch pad, or buttons, and a communication device such as a network board. A Web browser is installed in advance in each user terminal 14 according to this embodiment, and those application programs are executed. Through the Web browser, the user terminal 14 receives various services provided by the horse race betting ticket purchase mediation system 10. In this embodiment, users of the horse race betting ticket purchase mediation system 10 use the user terminals 14 to take such actions as obtaining information from the horse race betting ticket purchase mediation system 10 and issuing a betting request to the horse race betting ticket purchase mediation system 10.

In this embodiment, a plurality of races having different post times from one another are handled. Bets for a race are closed at a point that precedes the post time by a given length of time (for example, two minutes). The horse race betting ticket purchase mediation system 10 in this embodiment is designed to receive betting requests not only for a race having the horse race betting ticket purchase deadline (betting deadline) which arrives at the earliest time but also for a race having the betting deadline which arrives subsequently.

FIG. 2 is a function block diagram illustrating an example of functions relevant to a betting function out of functions that are implemented in the horse race betting ticket purchase mediation system 10 according to this embodiment. Other functions than those illustrated in FIG. 2 are also implemented in the horse race betting ticket purchase mediation system 10 according to this embodiment.

The horse race betting ticket purchase mediation system 10 according to this embodiment includes, in terms of function, a data storage unit 20, a betting request receiving unit 22, a betting request accumulating buffer 23, a processing unit 24, and a monitoring unit 26. The data storage unit 20 and the betting request accumulating buffer 23 are implemented mainly by the memory unit of the horse race betting ticket purchase mediation system 10. The rest of the components are implemented mainly by the control unit of the horse race betting ticket purchase mediation system 10.

Those components are implemented by executing a program that is installed in the horse race betting ticket purchase mediation system 10, which is a computer, with the control unit of the horse race betting ticket purchase mediation system 10. This program is provided to the horse race betting ticket purchase mediation system 10 via, for example, a computer-readable recording medium such as a CD-ROM or a DVD-ROM, or via a communication network such as the Internet.

The data storage unit 20 in this embodiment stores in advance account data, which includes, among others, a user ID for identifying a user who uses the horse race betting ticket purchase mediation system 10, a password for authenticating the user, and balance information indicating the amount of money paid by the user of the horse race betting ticket purchase mediation system 10 in advance to a business operator who manages the horse race betting ticket purchase mediation system 10 via direct deposit or the like. In this embodiment, one of the user terminals 14 accesses the horse race betting ticket purchase mediation system 10 via the Web browser and transmits a user ID and a password to the horse race betting ticket purchase mediation system 10. Under the condition that this user terminal 14 accesses a Web page disposed in the horse race betting ticket purchase mediation system 10 after the horse race betting ticket purchase mediation system 10 executes login processing (authentication processing) for the user terminal 14, the Web page is displayed on the display of the user terminal 14. The horse race betting ticket purchase mediation system 10 is designed so that, once the user terminal 14 transmits a user ID and a password to the horse race betting ticket purchase mediation system 10, a user ID associated with a user who is using the user terminal 14 can be identified by, for example, referring to authentication information received subsequently from the user terminal 14.

The betting request receiving unit 22 in this embodiment receives betting requests from the user terminals 14. Each betting request contains, for example, a race ID for identifying a race, a betting method (method type), a bet selection, and a purchased amount (bet amount). In response to the reception of a betting request, the betting request receiving unit 22 in this embodiment generates at least one piece of betting transaction detail information 30 an example of which is illustrated in FIG. 3, and outputs the betting transaction detail information 30 to the data storage unit 20. The betting transaction detail information 30 includes the information described above which is received from the relevant user terminal 14 and information set by the horse race betting ticket purchase mediation system 10 (for example, the user ID of a user who is making the betting request, a processed date, a reception number, a serial betting case number, and a reception established date/time). The betting transaction detail information 30 in this embodiment is generated on a betting unit-by-betting unit basis. In this embodiment, a date on which the betting request is received and betting processing is executed on the betting request by the horse race management system 12 is set as the value of a processed date included in the betting transaction detail information 30. A reception number included in the betting transaction detail information 30 is a number for identifying the betting request. The same reception number is assigned to pieces of the betting transaction detail information 30 that are associated with one session of requesting betting. For pieces of the betting transaction detail information 30 that have the same processed date, reception numbers are set in ascending order of the reception of betting requests. Among pieces of the betting transaction detail information 30 that have the same combination of a processed date and a reception number, a unique number is assigned to one betting unit as a serial betting case number. The betting transaction detail information 30 in this embodiment is identified uniquely by a combination of a processed date, a reception number, and a serial betting case number. The betting transaction detail information 30 in the initial state includes nil as the value of a reception established date/time. Once a betting request that is associated with the betting transaction detail information 30 is processed, a value is set as a reception established date/time which is described later. Accordingly, whether or not a betting request associated with the betting transaction detail information 30 has been processed (in other words, whether or not the betting request is unprocessed) can be determined by whether or not the betting transaction detail information 30 includes a value as the reception established date/time.

The betting request accumulating buffer 23 in this embodiment stores a betting request management queue 40 which is a queue for managing the processing order of betting requests. FIG. 4 is a diagram schematically illustrating an example of the betting request management queue 40. The betting request receiving unit 22 in this embodiment generates the betting transaction detail information 30 in the manner described above in response to the reception of abetting request and, at the same time, adds (enqueues) processing order management data 42 that is associated with the betting request to the tail end of the betting request management queue 40. The betting request management queue 40 in FIG. 4 is expressed so that pieces of the processing order management data 42 contained in the betting request management queue 40 are arranged from left to right in order. In other words, the leftmost processing order management data 42 corresponds to the head processing order management data 42 and the rightmost processing order management data 42 corresponds to the tail end processing order management data 42. The processing order management data 42 in this embodiment includes a reception number so that at least one piece of the betting transaction detail information 30 can be identified based on the processing order management data 42.

In principle, the processing unit 24 processes the betting requests received by the betting request receiving unit 22 in the order of reception. Under the condition that the betting request receiving unit 22 receives from the monitoring unit 26 to be described later an instruction to change places of the betting requests in the processing order, the processing unit 24 executes processing of changing places of pieces of processing order management data 42 included in the betting request management queue 40.

The monitoring unit 26 monitors an reception status of the betting requests received by the horse race betting ticket purchase mediation system 10. Depending on the result of monitoring, the monitoring unit 26 then notifies the processing unit 24 of the instruction to change places of the betting requests in the processing order. The monitoring unit 26 of the horse race betting ticket purchase mediation system 10 according to this embodiment executes the following monitoring processing at given time intervals (for example, one-minute intervals).

A description is now given with reference to a flow chart of FIG. 5 of an example of the flow of monitoring processing which is executed at given time intervals by the monitoring unit 26 of the horse race betting ticket purchase mediation system 10 according to this embodiment.

The monitoring unit 26 first identifies the number of pieces of processing order management data 42 included in the betting request management queue 40 (S101). The monitoring unit 26 then verifies whether or not the number identified in the processing of 5101 exceeds a given number X (S102).

Under the condition that the above-mentioned number exceeds the given number X (S102: Y), the monitoring unit 26 notifies the processing unit 24 of the instruction to change places of the betting requests in the processing order (S103). In response to this notification, the processing unit 24 executes processing of changing places of the pieces of processing order management data 42 included in the betting request management queue 40. Details of this processing of changing the places are described later.

Under the condition that it is verified in the processing of S102 that the above-mentioned number does not exceed the given number X (S102: N), or under the condition that the processing of S103 is finished, the processing illustrated in this processing example is brought to an end. The flow of the monitoring processing is not limited to the above-mentioned exemplary flow illustrated in FIG. 5.

A description is now given with reference to a flow chart of FIG. 6 of an example of the flow of processing that is executed by the horse race betting ticket purchase mediation system 10 according to this embodiment to transmit an instruction to execute betting processing.

The processing unit 24 first obtains (dequeues) the processing order management data 42 that is at the head of the betting request management queue 40 (S201). The processing unit 24 identifies at least one piece of the betting transaction detail information 30 that is stored in the data storage unit 20 and that is associated with the processing order management data 42 obtained in the processing of S201 (S202). The processing unit 24 then identifies, as an instruction target betting unit, a betting unit that is associated with one piece of the betting transaction detail information 30 out of pieces of betting transaction detail information 30 that have been identified in the processing of S202 and that have not been processed by processing of S204 which is described later (for example, a betting unit that is associated with a piece of the betting transaction detail information 30 that has the smallest serial betting case number of pieces of the betting transaction detail information 30 that have not been processed by processing of S204 described later) (S203). The processing unit 24 transmits to the horse race management system 12 an instruction to execute betting processing for the instruction target betting unit (S204). The processing unit 24 then determines whether or not there is a piece of the betting transaction detail information 30 that has been identified in the processing of S202 and that has not been processed by the processing of S204 (unprocessed piece of the betting transaction detail information 30) (S205). Under the condition that there is unprocessed information (S205: Y), the processing of S203 is executed. In this embodiment, the processing of S201 to the processing of S205 are repeated until the horse race betting ticket purchase mediation system 10 receives a request to end the processing. The flow of betting request processing is not limited to the exemplary flow illustrated in FIG. 6.

An example of the processing of changing places of the betting requests in the processing order is described below. FIG. 7 is a diagram schematically illustrating an example of how a plurality of pieces of processing order management data 42 are included in the betting request management queue 40 at a time point before the betting deadline of a first race. In FIG. 7, the number described on the upper side of the circle representing the processing order management data 42 indicates the processing order in the state of FIG. 7, and the number described on the lower side of the circle indicates the race ID for identifying a race as a betting target in the betting request corresponding to the processing order management data 42. Specifically, in the example of FIG. 7, the processing order management data 42 whose number described on the lower side of the circle representing the processing order management data 42 is “1” represents the betting request for the first race, and the processing order management data 42 whose number described on the lower side of the circle representing the processing order management data 42 is “2” represents the betting request for a second race.

When receiving from the monitoring unit 26 the instruction to change places of the betting requests in the processing order, the processing unit 24 determines whether or not, among pieces of processing order management data 42 whose places in the processing order from the head are the above-mentioned given number X or smaller, there is at least one piece of processing order management data 42 corresponding to the betting request for a race having the purchase deadline which does not arrive at the earliest time (in the example of FIG. 7, the betting request for the second race). Under the condition that there is such processing order management data 42, the processing unit 24 then identifies the at least one piece of the processing order management data 42. The processing unit 24 next changes places of pieces of the processing order management data 42 included in the betting request management queue 40 in the processing order so that the place of the identified piece of processing order management data 42 in the processing order from the head in the betting request management queue 40 is larger than the above-mentioned given number X. For example, while keeping the order relationship among pieces of processing order management data 42 corresponding to the betting requests for the second race, the processing unit 24 moves those pieces of processing order management data 42 to the tail end of the betting request management queue 40. FIG. 8 is a diagram schematically illustrating an example of how the plurality of pieces of the processing order management data 42 are stored in the betting request management queue 40 after the places of the pieces of processing order management data 42 included in the betting request management queue 40 are changed in the processing order in the state of FIG. 7. As illustrated in FIG. 8, after the places are changed as described above, the processing order management data 42 corresponding to the betting request for the first race is placed before the processing order management data 42 corresponding to the betting request for the second race in the betting request management queue 40, and an execution instruction to process the betting request for the first race is therefore given before an execution instruction to process the betting request for the second race.

The horse race management system 12 executes betting processing in response to an execution instruction that is received from the horse race betting ticket purchase mediation system 10 according to this embodiment. As described above, the horse race management system 12 according to this embodiment also executes betting processing in response to execution instructions that are received from other systems than the horse race betting ticket purchase mediation system 10. The horse race management system 12 in this embodiment executes betting processing in the order of reception of execution instructions.

Under the condition that betting processing that has been executed in response to an execution instruction received from the horse race betting ticket purchase mediation system 10 is finished, the horse race management system 12 transmits to the horse race betting ticket purchase mediation system 10 a message to the effect that the betting processing has been completed, along with information for identifying the execution instruction (e.g., a combination of a processed date, a reception number, and a serial betting case number) and a reception established date/time indicating the date/time of execution of the betting processing. The processing unit 24 receives the message informing of the completion of the betting processing, and sets the reception established date/time received from the horse race management system 12 as the value of a reception established date/time included in the betting transaction detail information 30 that is associated with this betting processing.

FIG. 9 is a graph schematically showing an example of a receiving tendency in the betting requests received by the horse race betting ticket purchase mediation system 10 according to this embodiment. In FIG. 9, the horizontal axis represents an elapsed time, and the vertical axis represents the total number of betting requests received in one minute. On the horizontal axis, abetting deadline T1 of the first race, a betting deadline T2 of the second race, a betting deadline T3 of a third race, a betting deadline T4 of a fourth race, a betting deadline T5 of a fifth race, and a betting deadline T6 of a sixth race are plotted. In FIG. 9, the number of betting requests for each race is expressed in the form of a stacked bar chart, and each bar as a whole represents the total number of betting requests received in one minute. Bars that are shown up to the betting deadline T1 of the first race each represent, in order from the bottom of the bar, the numbers of betting requests for the first race, the second race, the third race, the fourth race, the fifth race, and the sixth race. Bars that are shown from the betting deadline T1 of the first race up to the betting deadline T2 of the second race each represent, in order from the bottom of the bar, the numbers of betting requests for the second race, the third race, the fourth race, the fifth race, and the sixth race. Bars that are shown from the betting deadline T2 of the second race up to the betting deadline T3 of the third race each represent, in order from the bottom of the bar, the numbers of betting requests for the third race, the fourth race, the fifth race, and the sixth race. Bars that are shown from the betting deadline T3 of the third race up to the betting deadline T4 of the fourth race each represent, in order from the bottom of the bar, the numbers of betting requests for the fourth race, the fifth race, and the sixth race. Bars that are shown from the betting deadline T4 of the fourth race up to the betting deadline T5 of the fifth race each represent, in order from the bottom of the bar, the numbers of betting requests for the fifth race and the sixth race. Bars that are shown from the betting deadline T5 of the fifth race up to the betting deadline T6 of the sixth race each represent the number of betting requests for the sixth race.

As shown in FIG. 9, it is common for the betting requests received by the horse race betting ticket purchase mediation system 10 to be made in a concentrated manner immediately before the betting deadline . The number of betting requests that are yet to be processed by the horse race betting ticket purchase mediation system 10 may therefore exceed the given number X immediately before the betting deadline. In this embodiment, although the betting requests are processed in the order of reception in principle, under the condition that the number of unprocessed betting requests exceeds the given number X, the betting requests having the betting deadline which arrives sooner are processed preferentially. The number of betting requests that have been received but are not processed by the betting deadline is reduced in this manner. On the other hand, the betting requests for races having the betting deadlines which arrive after the betting deadline of a specific race that are received until that betting deadline are to be processed later, but those betting requests can be processed even after the betting deadline of the above-mentioned specific race. Those betting requests have therefore a good chance of being processed. In the horse race betting ticket purchase mediation system 10 according to this embodiment, the number of betting requests that have been received but are not processed by the betting deadline is reduced as described above.

The present invention is not limited to the embodiment described above.

For example, the processing order management data 42 may include data indicating a reception date/time of the betting request. The processing unit 24 may identify a time point that is a given period of time before (for example, one minute before) the time point at which the changing instruction is received from the monitoring unit 26, and exclude pieces of processing order management data 42 corresponding to betting requests that have been received before the identified time point from targets of the changing processing.

For example, the betting request accumulating buffer 23 may store waiting pooled data which is data that manages pieces of processing order management data 42 identified as pieces of processing order management data 42 whose places in the processing order are to be changed by the above-mentioned changing processing and has no data contained therein in the initial state. The processing unit 24 may dequeue, from the betting request management queue 40, among pieces of processing order management data 42 whose places in the processing order from the head are the above-mentioned upper limit X or smaller, a piece of processing order management data 42 corresponding to the betting request for a race having the purchase deadline which does not arrive at the earliest time, and add the dequeued piece of processing order management data 42 to the waiting pooled data. The processing unit 24 may then add (enqueue) the processing order management data 42 to the tail end of the betting request management queue 40 under the condition that a given timing arrives. The processing unit 24 may, for example, add (enqueue) pieces of processing order management data 42 corresponding to the betting requests received p minutes before the betting deadline that arrives at the earliest time to the tail end of the betting request management queue 40 p minutes after the betting deadline that arrives at the earliest time. The processing unit 24 may, for example, add (enqueue) the pieces of processing order management data 42 corresponding to the betting requests received p minutes before the betting deadline that arrives at the earliest time to the tail end of the betting request management queue 40 p minutes after the betting deadline of a race that is immediately before the race as the betting target of the betting requests. Under the condition that the betting deadline arrives, the processing unit 24 may, for example, process pieces of the processing order management data 42 contained in the waiting pooled data until there is no longer piece of the processing order management data 42 contained in the waiting pooled data before processing pieces of processing order management data 42 contained in the betting request management queue 40.

For example, the monitoring unit 26 may execute the above-mentioned monitoring processing at time intervals shorter than one minute (for example, five-second intervals). Under the condition that the betting request receiving unit 22 receives the betting request for the race having the betting deadline which arrives at the earliest time, the monitoring unit 26 may execute the above-mentioned monitoring processing.

For example, under the condition that a time period up to the betting deadline becomes shorter than a given time period, the processing unit 24 may verify whether or not, in order from the processing order management data 42 at the head of the betting request management queue 40, a piece of processing order management data 42 is the processing order management data 42 corresponding to the betting request for the race having the betting deadline which arrives at the earliest time. Then, under the condition that the piece of processing order management data 42 is the above-mentioned processing order management data 42, the processing unit 24 may execute the above-mentioned processing of S202 to S205, and under the condition that the piece of processing order management data 42 is not the above-mentioned processing order management data 42, the processing unit 24 may skip this piece of processing order management data 42 and execute the above-mentioned processing on the next piece of processing order management data 42.

For example, as illustrated in FIG. 10, the betting request accumulating buffer 23 may store a plurality of betting request management queues 40, each of which is associated with a period of time. The betting request receiving unit 22 in this case may add (enqueue), in response to reception of the betting request, a piece of processing order management data 42 that is associated with the betting request to the tail end of the betting request management queue 40 whose period of time includes a time point of the reception. Then, in the processing of S201, the processing unit 24 may obtain a piece of processing order management data 42 at the head of the betting request management queue 40 that has the earliest period of time associated thereto among the betting request management queues 40 including the processing order management data 42.

In this case, for example, the periods of time respectively associated with the betting request management queues 40 may be divided at every given time interval (for example, every one minute or every five minutes) . The periods of time respectively associated with the betting request management queues 40 may be divided by a time point at which the betting deadline arrives. Specifically, the periods of time associated with the betting request management queues 40 may be divided to obtain, for example, the betting request management queue 40 associated with a period of time up to the betting deadline of the first race, the betting request management queue 40 associated with a period of time from the betting deadline of the first race up to the betting deadline of the second race, . . . .

Under the condition that the plurality of betting request management queues 40 include pieces of processing order management data 42 the number of which exceeds a given upper limit number, the monitoring unit 26 may notify the processing unit 24 of the instruction to change places of the betting requests in the processing order. The processing unit 24 then may execute the processing of changing the places of the pieces of processing order management data 42 in response to this notification.

The processing unit 24 in this case may add (enqueue), for example, pieces of processing order management data 42 corresponding to the betting requests received p minutes before the betting deadline that arrives at the earliest time to the tail end of the betting request management queue 40 whose period of time includes time point that is p minutes after the betting deadline that arrives at the earliest time . The processing unit 24 may, for example, add (enqueue) the pieces of processing order management data 42 corresponding to the betting requests received p minutes before the betting deadline that arrives at the earliest time to the tail end of the betting request management queue 40 whose period of time includes a time point that is p minutes after the betting deadline of a race that is immediately before the race as the betting target of the betting requests.

The monitoring unit 26 may determine whether or not to notify the processing unit 24 of the instruction to change the places of the betting requests in the processing order based on, for example, an execution margin of processing to be executed after the betting deadline that arrives at the earliest time.

An example of a method of calculating the execution margin is now described. As shown in FIG. 9, in general, increasing tendencies of the betting requests are substantially similar to one another regardless of the race. It is therefore possible to estimate, based on, for example, an increasing tendency of the betting requests for the second race and subsequent races which have been received until the betting deadline of the first race, an increasing tendency of the betting requests for the second race and subsequent races during a period between the betting deadline of the first race to the betting deadline of the second race. For example, under the condition that data indicating the relative total number of betting requests associated with time points before the betting deadline is stored in advance in the data storage unit 20, based on the expression: (the number of betting requests for the second race and subsequent races at a time point that is n minutes before the betting deadline of the second race)=(the number of betting requests for the second race and subsequent races at a time point that is m minutes before the betting deadline of the second race)×(the relative total number of betting requests at the time point that is n minutes before the betting deadline)/(the relative total number of betting requests at the time point that is m minutes before the betting deadline), it is possible to estimate the number of betting requests for the second race and subsequent races at the time point that is n minutes before the betting deadline of the second race (in other words, the total number of betting requests at the time point that is n minutes before the betting deadline of the second race). In the same manner, the total number of betting requests at a time point t can also be estimated for the betting deadline of the second race.

It is thus possible from this estimation to calculate an estimated value of the total number of betting requests to be received after the betting deadline of the first race even before the betting deadline of the first race, and it is further possible to calculate the execution margin of processing to be executed by the processing unit 24 at the time point t that is at and after the betting deadline of the first race, based on, for example, the expression: (execution margin (t))=(given value Y)−(estimated value of the total number of betting requests at the time point t).

For example, even if the number of pieces of processing order management data 42 included in the betting request management queue 40 exceeds the given number X, under the condition that the sum of execution margins described above during k minutes after the purchase deadline that arrives at the earliest time (for example, (execution margin (1))+(execution margin (2))+ . . . +(execution margin (k))) is smaller than a predefined upper limit value of the sum of execution margins, the monitoring unit 26 may be inhibited from notifying the processing unit 24 of the instruction to change the places of the betting requests in the processing order.

The horse race betting ticket purchase mediation system 10, the horse race management system 12, and the user terminals 14 are not limited to the role allotment described above. For instance, the horse race betting ticket purchase mediation system 10 may additionally include the functions of the horse race management system 12 so that the processing unit 24 executes betting processing.

This embodiment maybe applied to other scenes than the purchase of a horse race betting ticket (e.g., the purchase of a boat race betting ticket, a bicycle race betting ticket, an auto race betting ticket, a football betting ticket, or a lottery). The concrete numerical values and texts given above, and the concrete numerical values and texts in the drawings are merely examples, and the present invention is not limited to those numerical values and texts.

1-12. (canceled)

13. A betting ticket purchase system, which is configured to receive, before a purchase deadline which arrives at an earliest time, a purchase request for a betting ticket having the purchase deadline which arrives after the purchase deadline,
the betting ticket purchase system comprising:
receiving means for receiving a purchase request for any one of a plurality of betting tickets having the purchase deadlines which arrive sequentially;
execution requesting means for sequentially requesting betting processing means to execute betting processing on the purchase request received by the receiving means based on places of pieces of processing order management data in a betting request management queue;
determining means for determining, based on the pieces of processing order management data of the betting request management queue, whether or not conditions that a number of purchase requests on which the betting processing means is yet to be requested to execute the betting processing is a given number or larger, the given number being a criterion based on which it is determined whether or not places of pieces of processing order management data relating to a purchase request for a betting ticket having the purchase deadline which does not arrive at the earliest time are to be changed, and that a plurality of purchase requests of the purchase requests on which the betting processing means is yet to be requested to execute the betting processing whose places in a reception order are smaller than the given number include the purchase request for the betting ticket having the purchase deadline which does not arrive at the earliest time are satisfied; and
changing means for changing, under a condition that it is determined that the conditions are satisfied, places of pieces of processing order management data in the betting request management queue relating to at least a part of the purchase requests for the betting tickets having the purchase deadlines which do not arrive at the earliest time so that places of the purchase requests for the betting tickets having the purchase deadlines which do not arrive at the earliest time in an order in which the execution requesting means requests the betting processing means to execute the betting processing are each the given number or larger.

14. The betting ticket purchase system according to claim 13, wherein under a condition that it is determined that the conditions are satisfied, the changing means changes the places of the pieces of processing order management data in the betting request management queue relating to the at least a part of the purchase requests for the betting tickets having the purchase deadlines which do not arrive at the earliest time so that the places of the purchase requests for the betting tickets having the purchase deadlines which do not arrive at the earliest time in the order in which the execution requesting means requests the betting processing means to execute the betting processing are each the given number or larger and that the places of the purchase requests for the betting tickets having the purchase deadlines which do not arrive at the earliest time in the order in which the execution requesting means requests the betting processing means to execute the betting processing are maintained.

15. The betting ticket purchase system according to claim 13, wherein under a condition that it is determined that the conditions are satisfied, the changing means changes the places of the pieces of processing order management data in the betting request management queue so that places of the purchase requests for the betting tickets having the purchase deadlines which arrive at the earliest time in the order in which the execution requesting means requests the betting processing means to execute the betting processing are smaller than the places of the purchase requests for the betting tickets having the purchase deadlines which do not arrive at the earliest time in the order in which the execution requesting means requests the betting processing means to execute the betting processing.

16. The betting ticket purchase system according to claim 13, wherein the changing means changes the places of the pieces of processing order management data in the betting request management queue under a condition that a number of purchase requests received in a unit of time exceeds the given number.

17. The betting ticket purchase system according to claim 13, wherein the execution requesting means requests the betting processing means to execute betting processing on the purchase request for the betting ticket having the purchase deadline which does not arrive at the earliest time after the purchase deadline which arrives at the earliest time.

18. The betting ticket purchase system according to claim 17, wherein the execution requesting means requests the betting processing means to execute betting processing on the purchase request for the betting ticket having the purchase deadline which does not arrive at the earliest time under a condition that a period of time corresponding to a period of time from reception of the purchase request to arrival of the purchase deadline which arrives at the earliest time elapses from the purchase deadline.

19. The betting ticket purchase system according to claim 13, wherein the execution requesting means requests the betting processing means to execute betting processing on the purchase request for the betting ticket having the purchase deadline which does not arrive at the earliest time after a purchase deadline of a betting ticket whose place in an arrival order is immediately before a place of the betting ticket in the arrival order.

20. The betting ticket purchase system according to claim 19, wherein the execution requesting means requests the betting processing means to execute betting processing on the purchase request for the betting ticket having the purchase deadline which does not arrive at the earliest time under a condition that a period of time corresponding to a period of time from reception of the purchase request to the purchase deadline which arrives at the earliest time elapses from the purchase deadline of the betting ticket whose place in the arrival order is immediately before the place of the betting ticket in the arrival order.

21. The betting ticket purchase system according to claim 13, wherein the changing means determines whether or not to change the places of the pieces of processing order management data in the betting request management queue based on an execution margin of processing to be executed after the purchase deadline which arrives at the earliest time.

22. The betting ticket purchase system according to claim 21, wherein the execution margin is determined based on a receiving tendency in the purchase request for the betting ticket.

23. A control method for a betting ticket purchase system, which is configured to receive, before a purchase deadline which arrives at an earliest time, a purchase request for a betting ticket having the purchase deadline which arrives after the purchase deadline,
the control method comprising:
a receiving step of receiving, by receiving means of the betting ticket purchase system, a purchase request for any one of a plurality of betting tickets having the purchase deadlines which arrive sequentially;
an execution requesting step of sequentially requesting, by execution requesting means of the betting ticket purchase system, betting processing means to execute betting processing on the purchase request received in the receiving step based on places of pieces of processing order management data in a betting request management queue;
a determining step of determining, by determining means of the betting ticket purchase system, based on the pieces of processing order management data of the betting request management queue, whether or not conditions that a number of purchase requests on which the betting processing means is yet to be requested to execute the betting processing is a given number or larger, the given number being a criterion based on which it is determined whether or not places of pieces of processing order management data relating to a purchase request for a betting ticket having the purchase deadline which does not arrive at the earliest time are to be changed, and that a plurality of purchase requests of the purchase requests on which the betting processing means is yet to be requested to execute the betting processing whose places in an reception order are smaller than the given number include the purchase request for the betting ticket having the purchase deadline which does not arrive at the earliest time are satisfied; and
a changing step of changing, by changing means of the betting ticket purchase system, under a condition that it is determined that the conditions are satisfied, places of pieces of processing order management data in the betting request management queue relating to at least a part of the purchase requests for the betting tickets having the purchase deadlines which do not arrive at the earliest time so that places of the purchase requests for the betting tickets having the purchase deadlines which do not arrive at the earliest time in an order in which the execution requesting means requests the betting processing means to execute the betting processing are each the given number or larger.

24. A non-transitory recording medium having recorded thereon a program for causing a computer to function as a betting ticket purchase system, which is configured to receive, before a purchase deadline which arrives at an earliest time, a purchase request for a betting ticket having the purchase deadline which arrives after the purchase deadline,
the program further causing the computer to function as:
receiving means for receiving a purchase request for any one of a plurality of betting tickets having the purchase deadlines which arrive sequentially;
execution requesting means for sequentially requesting betting processing means to execute betting processing on the purchase request received by the receiving means based on places of pieces of processing order management data in a betting request management queue;
determining means for determining, based on the pieces of processing order management data of the betting request management queue, whether or not conditions that a number of purchase requests on which the betting processing means is yet to be requested to execute the betting processing is a given number or larger, the given number being a criterion based on which it is determined whether or not places of pieces of processing order management data relating to a purchase request for a betting ticket having the purchase deadline which does not arrive at the earliest time are to be changed, and that a plurality of purchase requests of the purchase requests on which the betting processing means is yet to be requested to execute the betting processing whose places in a reception order are smaller than the given number include the purchase request for the betting ticket having the purchase deadline which does not arrive at the earliest time are satisfied; and
changing means for changing, under a condition that it is determined that the conditions are satisfied, places of pieces of processing order management data in the betting request management queue relating to at least a part of the purchase requests for the betting tickets having the purchase deadlines which do not arrive at the earliest time so that places of the purchase requests for the betting tickets having the purchase deadlines which do not arrive at the earliest time in an order in which the execution requesting means requests the betting processing means to execute the betting processing are each the given number or larger.
